(19) United States
(12) Patent Application Publication
(10) Pub. No.: US 2017/0223709 A1
(43) Pub. Date: Aug. 3, 2017

(54) METHOD AND APPARATUS FOR TRANSMITTING SIGNAL IN FULL-DUPLEX BASED MOBILE COMMUNICATION SYSTEM

(71) Applicant: ELECTRONICS AND TELECOMMICATIONS RESEARCH INSTITUTE, Daejeon (KR)

(72) Inventor: Gosan NOH, Daejeon (KR)

(21) Appl. No.: 15/402,303

(22) Filed: Jan. 10, 2017

(30) Foreign Application Priority Data
Jan. 28, 2016 (KR) 10-2016-0010991

(51) Int. Cl. H04W 72/04; H04W 74/08; H04W 36/00; H04L 5/14

(52) U.S. Cl. CPC H04W 72/0453; H04L 5/14; H04W 72/0446; H04W 74/0833; H04W 36/0005

(57) ABSTRACT

A signal transmitting method and device in a full-duplex based mobile communication system. It is set to perform a half-duplex transmission on at least one subframe of entire subframes configuring a frame and perform a full-duplex transmission on the other subframes. A signal is transmitted based on a frame.

### CROSS-REFERENCE TO RELATED APPLICATION

This application claims priority to and the benefit of Korean Patent Application No. 10-2016-0010991 filed in the Korean Intellectual Property Office on Jan. 28, 2016, the entire contents of which are incorporated herein by reference.

### BACKGROUND OF THE INVENTION

1. Field of the Invention

The present invention relates to a method and device for transmitting a signal in a full-duplex based mobile communication system.

2. Description of Related Art

In a wireless communication system, duplexing is a prerequisite for performing bi-directional communication. Particularly, a cellular mobile communication performs the duplexing for concurrent support of a downlink to a user terminal from a base station and an uplink to a base station from the user terminal. A frequency-division duplex (FDD) scheme for dividing a frequency resource and performing duplexing and a time-division duplex (TDD) scheme for dividing a time resource and performing duplexing are in most frequent use.

The FDD scheme and the TDD scheme allocate the frequency resource and the time resource so as to maintain orthogonality between the downlink and the uplink. This duplexing scheme for allocating an orthogonal resource to the downlink and the uplink is referred to as a half-duplex scheme. The half-duplex scheme has a merit of enabling the duplexing without interference between the uplink and the downlink, but also has a drawback that it is difficult to efficiently use the frequency resource. In detail, one frequency resource may support one of the downlink and the uplink at one time, a guard band is needed for the FDD scheme so as to maintain sufficient orthogonality, and a guard time is needed for the TDD scheme.

To overcome the drawback of the half-duplex scheme and improve the efficiency of using the frequency resource, a full-duplex scheme is researched. The full-duplex scheme represents a scheme for simultaneously operating the downlink and the uplink with the same frequency resource and the time resource, and in other words, it signifies that transmitting and receiving are simultaneously performed in the same band. It is known that the frequency efficiency may be doubled to the maximum according to the full-duplex scheme.

However, because of self-interference occurring when the transmitting and the receiving operations are simultaneously performed, a desired received signal may not be restored and a frequency efficiency gain via full-duplex may be degraded. Therefore, a fluent full-duplex operation may be performed when the influence caused by a self-interference signal is sufficiently removed by using a self-interference cancellation scheme.

The self-interference cancellation scheme includes antenna interference cancellation, analog interference cancellation, and digital interference cancellation. The antenna interference cancellation cancels self-interference by using a multiple antenna transmitting/receiving characteristic, and it may minimize the influence of self-interference by using an inter-antenna arrangement and polarization characteristic or through an RF absorber. The analog interference cancellation reduces self-interference in an RF domain by using an analog RF component such as a circulator or enables the self-interference cancellation by realizing an analog RF circuit. The digital interference cancellation detects a baseband self-interference signal in a digital domain and cancels the detected self-interference signal from the baseband received signal.

An effort for applying the full-duplex to the actual communication system has been focused on a Wi-Fi-based system. This is because the Wi-Fi system performing a low-power transmission in indoor environments has a narrower dynamic range and better channel estimation performance than the cellular system with great transmission power of the base station so it is advantageous in canceling the self-interference signal.

However, small cells have been recently standardized and developed to be commercially available by the 3GPP LTE-A standards so it has been required to apply the full-duplex to which self-interference cancellation is applied to the cellular system. A frame structure of the existing cellular system is designed to satisfy the FDD and TDD support, which is not appropriate for the full-duplex.

### SUMMARY OF THE INVENTION

The present invention has been made in an effort to provide a method and device for performing a signal transmission based on a frame appropriate for a full-duplex based cellular communication system.

The present invention has been made in another effort to provide a signal transmitting method and device for efficiently canceling self-interference by using a frame appropriate for a full-duplex based cellular communication system.

An exemplary embodiment of the present invention provides a method for transmitting a signal in a method for transmitting a signal in a full-duplex based mobile communication system, including: setting to perform a half-duplex transmission on at least one subframe of entire subframes configuring a frame and setting to perform a full-duplex transmission on the other subframes; and transmitting a signal based on the frame.

The setting may include setting a half-duplex transmission for a downlink transmission to a first subframe having one of a synchronization signal for synchronization, a broadcasting signal for transmitting system information, and a reference signal for channel estimation from among subframes configuring a downlink frame.

The setting of a half-duplex transmission may include one of: setting a half-duplex transmission over an entire frequency band of the first subframe; and setting a half-duplex transmission over a specific portion of frequency band having the synchronization signal, the broadcasting signal, or the reference signal from among the entire frequency band of the first subframe.

The setting may include setting a half-duplex transmission to the subframe including a random access channel for setting up a radio link at an initial access or a handover requested by a terminal.

The setting of a half-duplex transmission may include: setting a half-duplex transmission over the entire frequency band of the subframe including the random access channel; and setting a half-duplex transmission to part of the frequency band including a random access channel from among the entire frequency band of the subframe including the random access channel.

The transmitting of a signal may include: initializing a subframe counter and starting a count; determining whether to set a full-duplex transmission for a subframe corresponding to the subframe counter; performing a full-duplex transmission allowable for a simultaneous transmission to a downlink and an uplink when a full-duplex transmission is set to the corresponding subframe; and performing a half-duplex transmission allowable for a transmission to a downlink or an uplink when a full-duplex transmission is not set to the corresponding subframe.

Another embodiment of the present invention provides a method for transmitting a signal in a full-duplex based mobile communication system, including: setting to perform a half-duplex transmission on part of symbols in a subframe configuring a frame, and setting to perform a full-duplex transmission on the other symbols; and transmitting a signal based on the frame.

The setting may include setting a half-duplex transmission to a symbol corresponding to a control area of one subframe, and setting a full-duplex transmission to the other symbols except the control area.

The control area may include at least one of a channel format indicator (CFI) channel, a hybrid automatic repeat request (HARQ) indicator (HI) channel, and a control channel.

Yet another embodiment of the present invention provides a device for transmitting a signal in a full-duplex based mobile communication system, including: a radio frequency converter for transmitting/receiving a signal through an antenna; and a processor connected to the radio frequency converter and transmitting a signal based on a frame, wherein the processor includes: a full-duplex transmission determiner for setting to perform a half-duplex transmission to at least one subframe from among entire subframes configuring a frame and setting to perform a full-duplex transmission to the other subframes; and a transmission processor for transmitting a signal based on the frame.

The full-duplex transmission determiner may set a half-duplex transmission for a downlink transmission over an entire frequency band of a first subframe having one of a synchronization signal for synchronization, a broadcasting signal for transmitting system information, and a reference signal for channel estimation from among subframes configuring a downlink frame, or part of the frequency band having the signal in the first subframe.

The full-duplex transmission determiner may set a half-duplex transmission to the entire frequency band of a subframe having a random access channel for setting up a radio link at an initial access or a handover requested by the terminal or the frequency band having the random access channel in the subframe.

The full-duplex transmission processor may perform a half-duplex transmission to a control area of one subframe and may perform a full-duplex transmission to the other portion except the control area.

The processor may further include a subframe counter for counting a subframe, and the transmission processor may perform a full-duplex transmission allowable for a simultaneous transmission to a downlink and an uplink when a full-duplex transmission is set to a subframe corresponding to the subframe counter, and it may perform a half-duplex transmission allowable for a transmission to a downlink or an uplink when a full-duplex transmission is not set to the corresponding subframe.

### BRIEF DESCRIPTION OF THE DRAWINGS

FIG. 1 shows a network environment of a full-duplex based mobile communication system according to an exemplary embodiment of the present invention.

FIG. 2 shows a configuration of a transceiver of a base station according to an exemplary embodiment of the present invention.

FIG. 3 shows another configuration of a transceiver of a base station according to an exemplary embodiment of the present invention.

FIG. 4 shows a configuration of a frame according to a first exemplary embodiment of the present invention.

FIG. 5 shows a configuration of a frame according to a second exemplary embodiment of the present invention.

FIG. 6 shows a configuration of a frame according to a third exemplary embodiment of the present invention.

FIG. 7 shows a configuration of a frame according to a fourth exemplary embodiment of the present invention.

FIG. 8 shows a configuration of a frame according to a fifth exemplary embodiment of the present invention.

FIG. 9 shows a flowchart of a method for transmitting a signal according to an exemplary embodiment of the present invention.

FIG. 10 shows a flowchart of a signal transmitting device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A terminal may designate a mobile terminal (MT), a mobile station (MS), an advanced mobile station (AMS), a high reliability mobile station (HR-MS), a subscriber station (SS), a portable subscriber station (PSS), an access terminal (AT), or user equipment (UE), and it may include entire or partial functions of the MT, the MS, the AMS, the HR-MS, the SS, the PSS, the AT, or the UE.

A method for a full-duplex based mobile communication system according to an exemplary embodiment of the present invention to transmit a signal and a device thereof will now be described with reference to accompanying drawings.

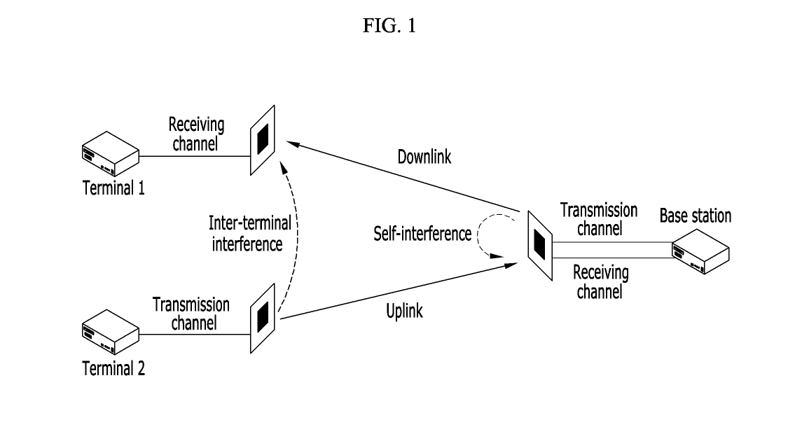

FIG. 1 shows a network environment of a full-duplex based mobile communication system according to an exemplary embodiment of the present invention.

Regarding the full-duplex based cellular communication system, as shown in FIG. 1, one base station and a plurality of terminals are provided in a cell, and the base station performs a full-duplex function. The base station transmits a transmission signal through a transmission channel and simultaneously receives a received signal through a receiving channel. The terminal, at the corresponding point of time, performs a receiving operation for a specific terminal and performs a transmission operation for another specific terminal.

The full-duplex operation generates interference. The transmission signal transmitted by the base station, that is, a self-transmission signal, is provided to a receiving device of the base station, and it functions as an interference signal that is stronger than a valid received signal that is received through a receiving channel, signifying that self-interference of the base station is generated. Further, inter-terminal interference from a transmission terminal to a receiving terminal is generated. The inter-terminal interference generates a small interference influence because transmission power of the terminal is relatively small and the terminals are separated from each other. However, the influence of self-interference of the base station is big since the transmitting antenna and the receiving antenna of the base station are provided to be very close to each other.

In an exemplary embodiment of the present invention, in the case of a full-duplex operation, initial self-interference is controlled by use of a multi-antenna or a polarization antenna, and digital self-interference cancellation is then performed. In addition to this, analog self-interference cancellation in the RF domain may be performed. Further, the self-interference cancellation is performed in consideration of the small cell environment, in which transmission power of the base station is less than a macro cell environment, and in which mobility of the terminal is low.

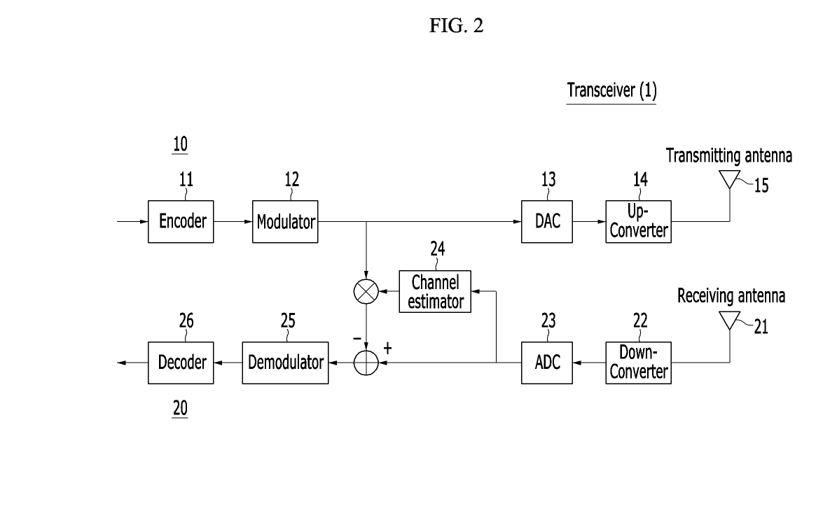

FIG. 2 shows a configuration of a transceiver of a base station according to an exemplary embodiment of the present invention.

As shown in FIG. 2, the transceiver 1 of the base station includes a transmitter 10 including an encoder 11, a modulator 12, a digital-to-analog converter (DAC) 13, an up-converter 14, and a transmitting antenna 15, and a receiver 20 including a receiving antenna 21, a down-converter 22, an analog-to-digital converter (ADC) 23, a channel estimator 24, a demodulator 25, and a decoder 26.

A transmission signal is processed while passing through respective constituent elements of the transmitter 10 and is transmitted through the transmitting antenna 15, and a received signal input through the receiving antenna 25 is processed while passing through respective constituent elements of the receiver 20 and is then decoded.

The received signal at this time includes an uplink signal from the terminal and a self-interference signal. Therefore, the uplink signal from the terminal is restored through a self-interference channel estimation operation and a self-interference cancellation operation. Here, self-interference cancellation in the digital domain is performed. That is, the channel estimator 24 performs channel estimation on the signal from the ADC 23, and cancels the self-interference signal included in the received signal from the ADC 23 based on a result of the channel estimation and a signal from the modulator 12. The demodulator 26 restores the received signal from which the self-interference signal is canceled.

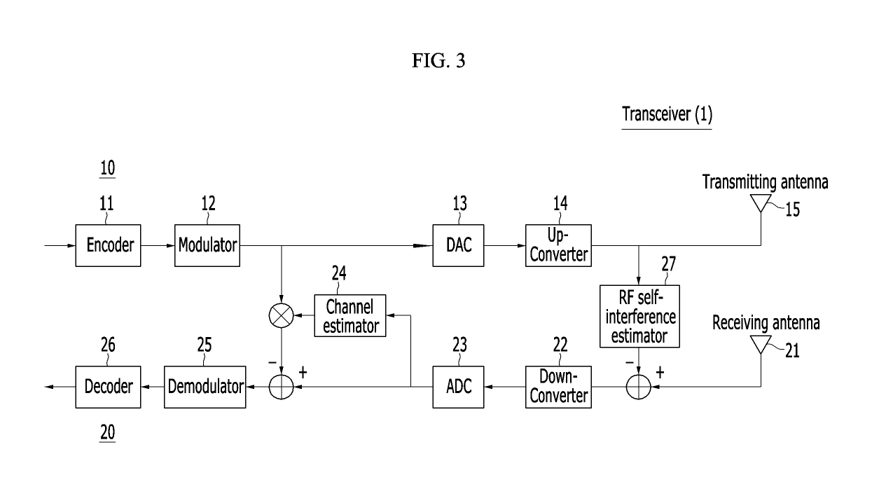

FIG. 3 shows another configuration of a transceiver of a base station according to an exemplary embodiment of the present invention.

As shown in FIG. 3, the transceiver 1 of the base station includes a transmitter 10 and a receiver 20, wherein configurations of the transmitter 10 and the receiver 20 correspond to the transceiver shown in FIG. 2, and the receiver 20 further includes an RF self-interference estimator 27.

In addition to the above-noted self-interference cancellation in the digital domain, self-interference cancellation in an RF domain may be performed. For this purpose, the RF self-interference estimator 27 is additionally used, wherein the RF self-interference estimator 27 performs self-interference cancellation in the RF domain, and in this instance, a substantial amount of self-interference signal is canceled. A process for canceling self-interference is performed in the digital domain for the remaining self-interference component.

A precise frame synchronization between the transmission signal and the received signal, and accurate channel estimation on the self-interference signal are needed so as to properly perform the above-noted self-interference cancellation operation. During the frame synchronization and channel estimation operation, pilot contamination caused by self-interference according to full-duplex transmitting/receiving is generated to degrade frame synchronization and channel estimation performance. As a result, the self-interference cancellation is not efficiently performed and the full-duplex operation is not efficiently performed.

In an exemplary embodiment of the present invention, a frame for an efficient full-duplex operation is generated. In detail, a frame configured to perform half-duplex transmitting/receiving on a time and frequency resource used for the purpose of frame synchronization and channel estimation and to perform full-duplex transmitting/receiving on a time and frequency resource used for the purpose of data transmission is generated.

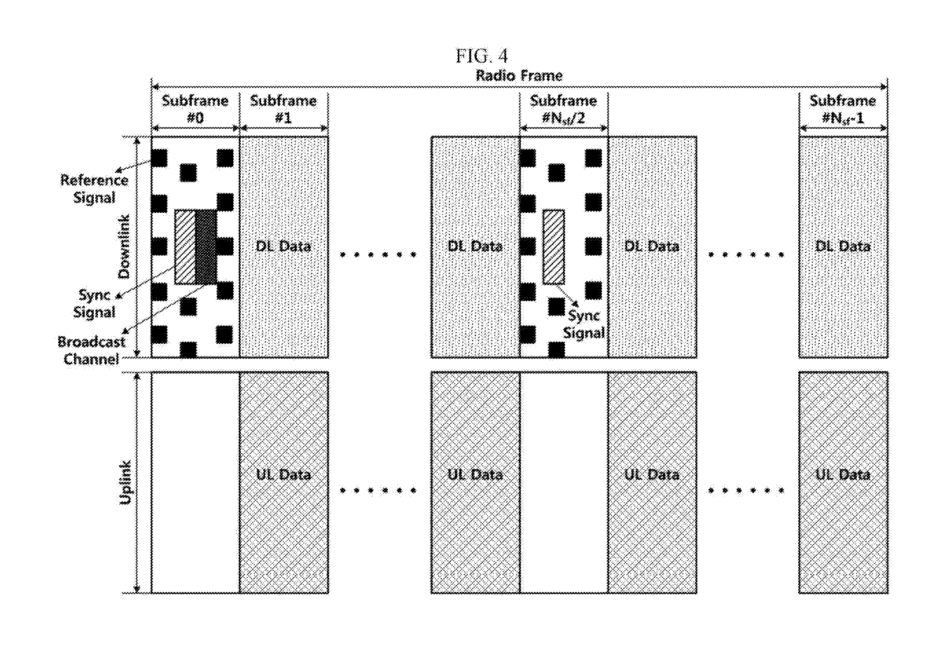

FIG. 4 shows a configuration of a frame according to a first exemplary embodiment of the present invention.

The frame according to a first exemplary embodiment of the present invention, as shown in FIG. 4, includes a plurality of subframes. When a synchronization signal (or a sync signal) for synchronization, a broadcast channel for transmitting system information, or a reference signal for channel estimation is provided to a specific subframe from among the subframes configuring the entire frame of the downlink, a half-duplex transmission for a downlink is performed to the corresponding subframe, and a full-duplex transmission for simultaneously performing a downlink transmission and an uplink transmission is performed to the remaining subframes including a data channel. For better comprehension and ease of description, regarding the downlink frame, the subframes where the half-duplex transmission is performed will be referred to as first subframes, and the subframes where the full-duplex transmission is performed will be referred to as second subframes.

In this instance, the half-duplex transmission may be performed to the entire first subframes becoming a half-duplex transmission target, and the half-duplex transmission may be performed to part of the frequency band in which a signal component is provided from among the first subframes. A subframe period with a signal component may be determined by considering a coherence time of the channel or system performance, and the subframe period may be determined to be shorter than the coherence time of the channel.

Here, the subframe may include a channel format indicator (CFI) channel, a hybrid automatic repeat request (HARQ) indicator (HI) channel, and a control channel.

The frame according to a first exemplary embodiment of the present invention is configured with the first subframe for performing a half-duplex transmission and the second subframe for performing a full-duplex transmission so it may perform a full-duplex operation without the pilot contamination for synchronization and channel estimation. Some subframes may perform a half-duplex transmission for the downlink instead of the full-duplex transmission to lose a data rate, but the loss of the data rate may be minimized when considering a characteristic of the cellular communication in which a downlink transmitted amount is much less than an uplink transmitted amount.

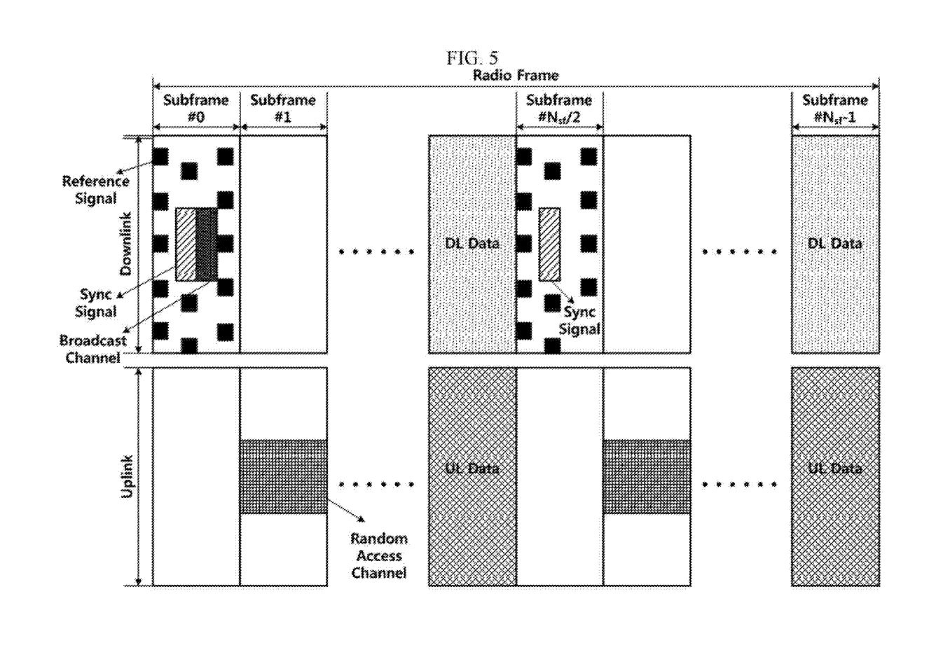

FIG. 5 shows a configuration of a frame according to a second exemplary embodiment of the present invention.

As shown in FIG. 5, the frame according to a second exemplary embodiment of the present invention may include a random access channel for setting up a radio link for an initial access to the uplink or a handover requested by the terminal. It is possible in the uplink to set the subframe having a random access channel to undergo a half-duplex transmission. For convenience of description, it is possible in the uplink frame to refer to the subframes undergoing a half-duplex transmission as third subframes.

In the uplink, the subframe with a random access channel is set to be a half-duplex transmission target, or as will be described hereinafter, part of the frequency band of the subframe including a random access channel may be set to be a half-duplex transmission target. Therefore, the full-duplex operation may be performed without generating interference to the initial generation of a link by the terminal.

Regarding the frame structure for a full-duplex transmission according to the above-described exemplary embodiments, the synchronization signal, the broadcasting signal, the reference signal, and the random access channel restricted in the full-duplex transmission may occupy part of the entire frequency band. Therefore, instead of limiting the full-duplex transmission in the entire region of the corresponding subframe (the first and third subframes), the frame structure for limiting the full-duplex transmission of the frequency band occupied by the signal or the channel may be applied.

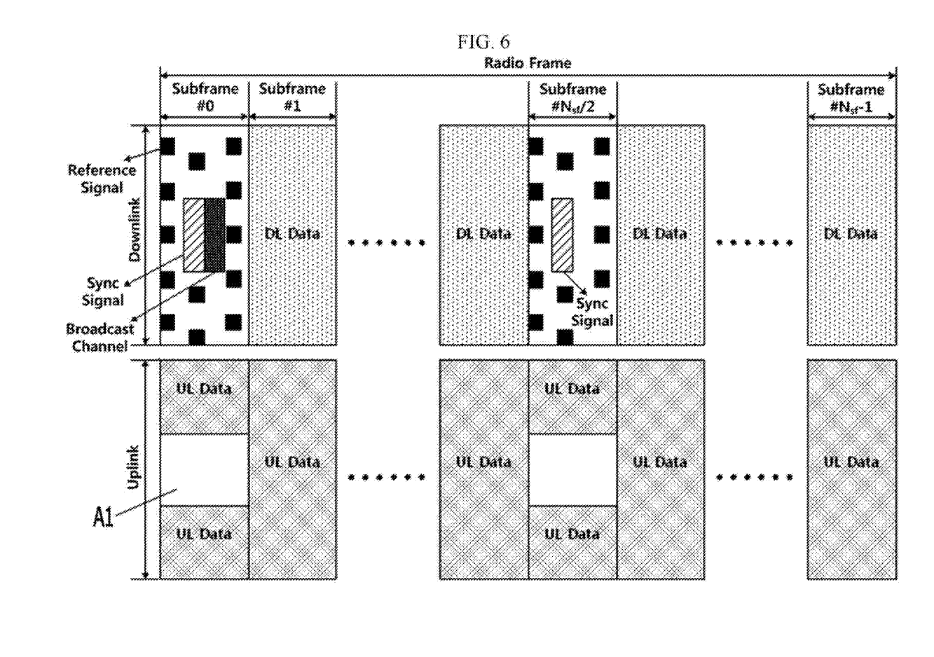

FIG. 6 shows a configuration of a frame according to a third exemplary embodiment of the present invention.

As shown in FIG. 6, the frame structure according to a third exemplary embodiment of the present invention is formed in a like manner of the above-described first exemplary embodiment, wherein the half-duplex transmission is applied to the first subframe that is a subframe for transmitting the synchronization signal, the broadcasting signal, or the reference signal, and the full-duplex transmission is applied to the second subframe that is another subframe for transmitting data. Differing from the first exemplary embodiment, the full-duplex transmission is not limited in the entire frequency band of the first subframe, but the full-duplex transmission is limited in the frequency band (referred to as a setting signal transmitting area) occupied by the synchronization signal, the broadcasting signal, or the reference signal in the first subframe. That is, partial frequency band full-duplex transmission limitation is performed. Therefore, as shown in FIG. 6, the half-duplex transmission is applied to the setting signal transmitting area A1 in the first subframe, and the full-duplex transmission is applied to the remaining frequency band.

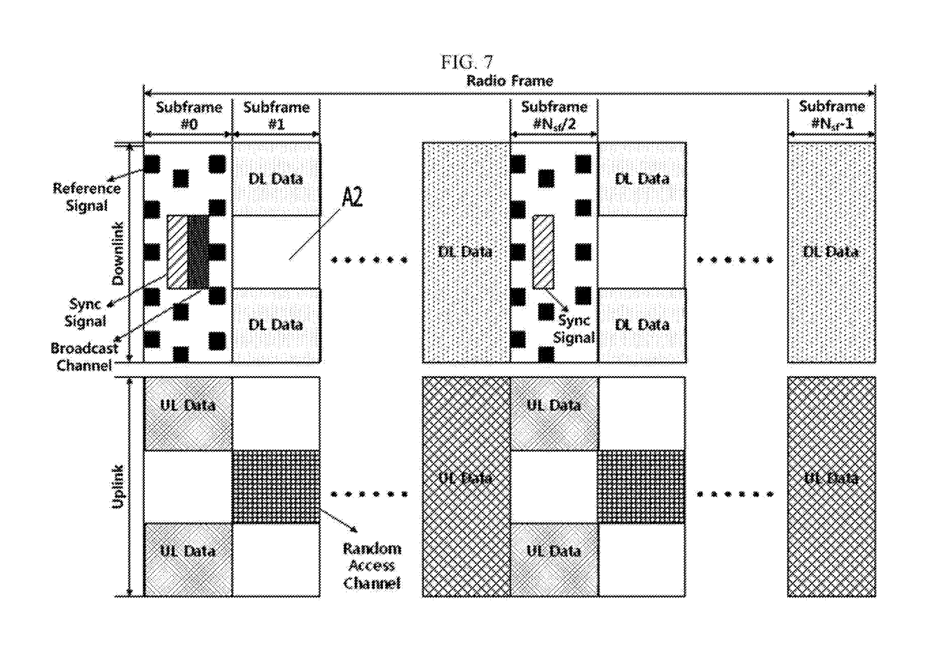

FIG. 7 shows a configuration of a frame according to a fourth exemplary embodiment of the present invention.

As shown in FIG. 7, the frame structure according to a fourth exemplary embodiment of the present invention is formed in a like manner of the above-described second exemplary embodiment, and a half-duplex transmission is applied to the third subframe that is a subframe having a random access channel. Differing from the second exemplary embodiment, the full-duplex transmission is not limited in the entire frequency band of the third subframe, but the full-duplex transmission is limited in part of the frequency band (referred to as a setting signal transmitting area) having a random access channel in the third subframe. That is, partial frequency band full-duplex transmission limitation is performed. Therefore, as shown in FIG. 7, the half-duplex transmission is applied to the setting signal transmitting area A2 in the third subframe, and the full-duplex transmission is applied to the remaining frequency band. FIG. 7 shows that the full-duplex transmission limitation according to a third exemplary embodiment is applied and the full-duplex transmission limitation according to a fourth exemplary embodiment is applied.

In another way, some symbols of the subframe may be used for the purpose of a half-duplex transmission, and other symbols may be used for the purpose of a full-duplex transmission. For example, the symbols corresponding to a control area of a former portion of the subframe may be transmitted by the downlink (i.e. half-duplex transmission), and the other symbols except for those of the control area may be used for the full-duplex transmission of the downlink and the uplink.

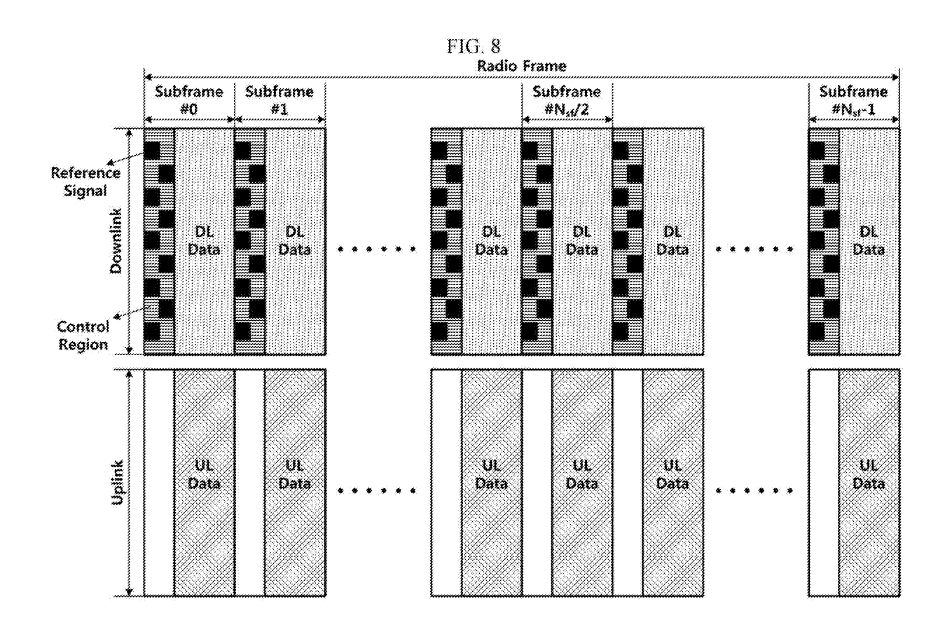

FIG. 8 shows a configuration of a frame according to a fifth exemplary embodiment of the present invention.

As shown in FIG. 8, regarding the frame structure according to a fifth exemplary embodiment of the present invention, in each subframe, the half-duplex transmission is applied to the control area, and the full-duplex transmission of the downlink and the uplink is applied to the other area except for the control area.

The control area may include a reference signal, a channel format indicator (CFI) channel, a hybrid ARQ indicator (HI) channel, and a control channel. In this case, each subframe may perform channel estimation for self-interference cancellation so the full-duplex communication appropriate for the case when the channel is relatively frequently changed may be allowable.

The frame structure for a full-duplex transmission according to the above-described exemplary embodiments of the present invention may apply a multi-carrier transmission-based multiple access scheme available for resource allocation for respective times and frequencies. For example, multiple access schemes such as the orthogonal frequency division multiple access (OFDMA), the single-carrier frequency division multiple access (SC-FDMA), the filter bank to multi-carrier (FBMC), and the generalized frequency division multiplexing (GFDM) are applicable. One multiple access scheme may be concurrently applied to the downlink and the uplink or different multiple access schemes may be applied to the downlink and the uplink.

A method for transmitting a signal based on a frame structure according to an exemplary embodiment of the present invention will now be described.

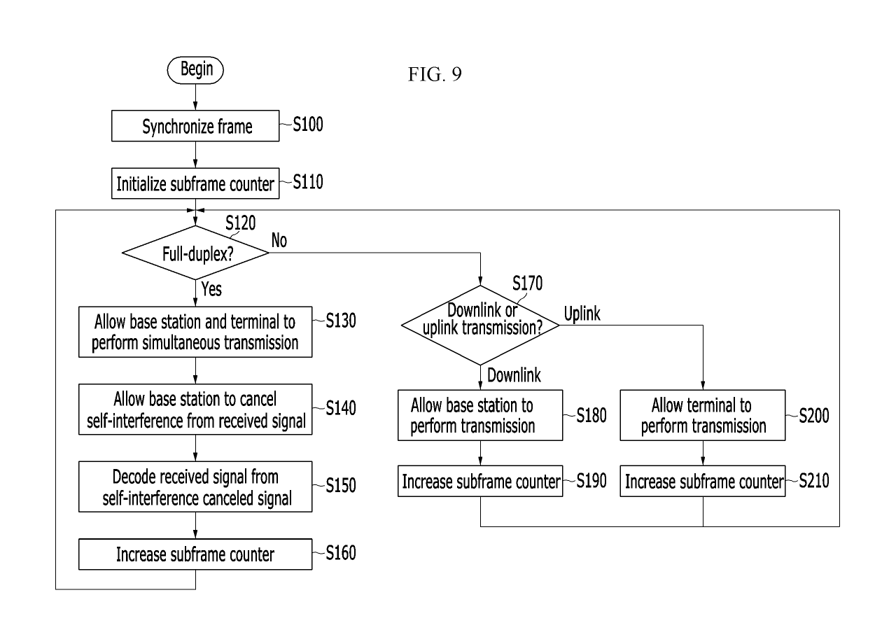

FIG. 9 shows a flowchart of a method for transmitting a signal according to an exemplary embodiment of the present invention.

Here, in a like manner of the above-described exemplary embodiments, regarding the frame structure, the half-duplex transmission is applied to the entire frequency band of a specific subframe or part of the frequency band of a specific subframe, and the full-duplex transmission is applied to the other subframes.

As shown in FIG. 9, a downlink frame is synchronized with an uplink frame (S100). A subframe counter is initialized (S110).

The full-duplex transmission for a specific subframe is limited based on the frame structure according to an exemplary embodiment of the present invention. In this case, it may be determined whether the corresponding subframe is a full-duplex transmission limiting target by comparing a value of a subframe counter and a value of a predetermined specific subframe. In another way, the subframe corresponding to the current counter value may be determined to be the full-duplex transmission limiting target for performing a half-duplex transmission according to whether the subframe corresponds to the above-described synchronization signal, the reference signal, the broadcasting signal, the random access channel, or the control area.

It is determined whether to limit the full-duplex transmission on the current subframe (S120), and when the current subframe is not the full-duplex transmission limiting target, the full-duplex transmission is performed. Accordingly, the base station and the terminal simultaneously perform a transmission (S130).

In this instance, the base station receives a signal from the terminal, and performs a self-interference cancellation operation on the received signal (S140). The self-interference cancellation operation will be described in detail in a later portion of the specification. The base station decodes the interference-canceled received signal (S150). A counter value of the subframe is increased by a predetermined value (S160).

When the current subframe is a full-duplex transmission limiting target in the step S120, it is determined whether to perform a transmission on one of the downlink and the uplink, that is, a half-duplex transmission on the downlink or the uplink (S170). When the downlink transmission is determined, the base station performs a transmission (S180). The counter value of the subframe is increased by a predetermined value (S190).

When the uplink transmission is determined in the step S170, the terminal performs a transmission. Hence, the base station does not perform a transmission, receives a signal from the terminal, and processes the signal (S200). The counter value of the subframe is increased by a predetermined value (S210).

As described, the counter value of the subframe is increased after the full-duplex or half-duplex transmission, it returns to the step S120, and the above-described operation is repeatedly performed.

In an exemplary embodiment of the present invention, when a plurality of terminals are provided in the cell, it may be possible to allocate different terminals for respective frequency groups, and perform a full-duplex operation for the respective frequency groups.

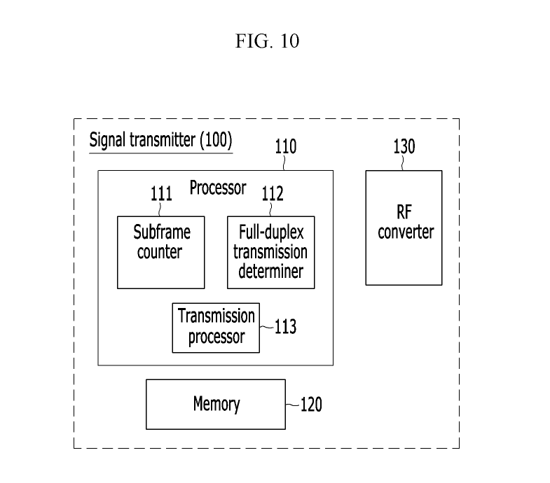

FIG. 10 shows a flowchart of a signal transmitting device according to an exemplary embodiment of the present invention.

As shown in FIG. 10, the signal transmitting device 100 includes a processor 110, a memory 120, and a radio frequency (RF) converter 130. The processor 110 may be configured to realize the methods described with reference to FIG. 1 to FIG. 9.

For this purpose, the processor 110 includes a subframe counter 111, a full-duplex transmission determiner 112, and a transmission processor 113.

The subframe counter 111 counts the subframes, and the counter value is increased by a predetermined value when a transmission on a random subframe is performed.

The full-duplex transmission determiner 112 determines whether to apply a full-duplex transmission for respective subframes. As described above, the full-duplex transmission determiner 112 sets the synchronization signal, the broadcasting signal for transmitting system information, the reference signal for channel estimation, the random access channel, and the entire frequency band or part of the frequency band of the subframe with the control area as the half-duplex transmission setting, that is, the full-duplex transmission limiting target.

The transmission processor 113 is allowable for a simultaneous transmission to the downlink and the uplink and is operated to perform the full-duplex transmission regarding the subframe to which the full-duplex transmission is applied, and it is allowable for a transmission to the downlink or the uplink regarding the subframe to which the half-duplex transmission is applied. When the transmission to the uplink is available, the base station does not perform a transmission and receives a signal from the terminal.

The memory 120 is connected to the processor 110 and stores various kinds of information on the operation of the processor 110. The memory 120 may be provided inside or outside the processor, and the memory may be connected to the processor 110 through various means. The memory represents various forms of volatile or non-volatile storage media, and for example, the memory may include a read-only memory (ROM) and a random access memory (RAM).

The RF converter 130 is connected to the processor 110 and transmits or receives radio signals.

According to the exemplary embodiment of the present invention, by using the frame structure for variably using the half-duplex for synchronization, channel estimation, and system information transmission and the full-duplex for data transmission in the full-duplex based cellular communication system, the full-duplex operation may be performed without deterioration of self-interference cancellation performance caused by pilot contamination for synchronization and channel estimation thereby improving the frequency efficiency.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting a signal in a full-duplex based mobile communication system, the method comprising:
setting to perform a half-duplex transmission on at least one subframe of entire subframes configuring a frame and setting to perform a full-duplex transmission on the other subframes; and
transmitting a signal based on the frame.

2. The method of claim 1, wherein the setting includes:
setting a half-duplex transmission for a downlink transmission to a first subframe having one of a synchronization signal for synchronization, a broadcasting signal for transmitting system information, and a reference signal for channel estimation from among subframes configuring a downlink frame.

3. The method of claim 2, wherein the setting of a half-duplex transmission includes one of:
setting a half-duplex transmission over an entire frequency band of the first subframe; and
setting a half-duplex transmission over a specific portion of frequency band having the synchronization signal, the broadcasting signal, or the reference signal from among the entire frequency band of the first subframe.

4. The method of claim 1, wherein the setting includes:
setting a half-duplex transmission to the subframe including a random access channel for setting up a radio link at an initial access or a handover requested by a terminal.

5. The method of claim 4, wherein the setting of a half-duplex transmission includes:
setting a half-duplex transmission over the entire frequency band of the subframe including the random access channel; and
setting a half-duplex transmission to part of the frequency band including a random access channel from among the entire frequency band of the subframe including the random access channel.

6. The method of claim 1, wherein the transmitting of a signal includes:
initializing a subframe counter and starting a count;
determining whether to set a full-duplex transmission for a subframe corresponding to the subframe counter;
performing a full-duplex transmission allowable for a simultaneous transmission to a downlink and an uplink when a full-duplex transmission is set to the corresponding subframe; and
performing a half-duplex transmission allowable for a transmission to a downlink or an uplink when a full-duplex transmission is not set to the corresponding subframe.

7. A method for transmitting a signal in a full-duplex based mobile communication system, the method comprising:
setting to perform a half-duplex transmission on part of symbols in a subframe configuring a frame, and setting to perform a full-duplex transmission on the other symbols; and
transmitting a signal based on the frame.

8. The method of claim 7, wherein the setting includes:
setting a half-duplex transmission to a symbol corresponding to a control area of one subframe, and setting a full-duplex transmission to the other symbols except the control area.

9. The method of claim 7, wherein the control area includes at least one of a channel format indicator (CFI) channel, a hybrid automatic repeat request (HARQ) indicator (HI) channel, and a control channel.

10. A device for transmitting a signal in a full-duplex based mobile communication system, the device comprising:
a radio frequency converter for transmitting/receiving a signal through an antenna; and
a processor connected to the radio frequency converter and transmitting a signal based on a frame,
wherein the processor includes:
a full-duplex transmission determiner for setting to perform a half-duplex transmission to at least one subframe from among entire subframes configuring a frame and setting to perform a full-duplex transmission to the other subframes; and
a transmission processor for transmitting a signal based on the frame.

11. The device of claim 10, wherein:
the full-duplex transmission determiner sets a half-duplex transmission for a downlink transmission over an entire frequency band of a first subframe having one of a synchronization signal for synchronization, a broadcasting signal for transmitting system information, and a reference signal for channel estimation from among subframes configuring a downlink frame, or part of the frequency band having the signal in the first subframe.

12. The device of claim 10, wherein:
the full-duplex transmission determiner sets a half-duplex transmission to the entire frequency band of a subframe having a random access channel for setting up a radio link at an initial access or a handover requested by the terminal or the frequency band having the random access channel in the subframe.

13. The device of claim 10, wherein:
the full-duplex transmission processor performs a half-duplex transmission to a control area of one subframe and performs a full-duplex transmission to the other portion except the control area.

14. The device of claim 10, wherein:
the processor further includes a subframe counter for counting a subframe, and
the transmission processor performs a full-duplex transmission allowable for a simultaneous transmission to a downlink and an uplink when a full-duplex transmission is set to a subframe corresponding to the subframe counter, and it performs a half-duplex transmission allowable for a transmission to a downlink or an uplink when a full-duplex transmission is not set to the corresponding subframe.
